(19) United States
(12) Patent Application Publication
(10) Pub. No.: US 2008/0049288 A1
(43) Pub. Date: Feb. 28, 2008

(54) PRISM SCANNER AND DISPLAY DEVICE USING DIFFRACTIVE OPTICAL MODULATOR AND PRISM SCANNER

(75) Inventor: Sang Kyeong Yun, Suwon (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/844,289

(22) Filed: Aug. 23, 2007

(30) Foreign Application Priority Data
Aug. 23, 2006 (KR) 1020060079923

(51) Int. Cl. G02B 26/10

(52) U.S. Cl. 359/211

(57) ABSTRACT

Disclosed herein are a prism scanner and a display device using an optical modulator and the prism scanner. The prism scanner includes a prism scanning unit, a drive motor, and a scanner driving circuit. The prism scanning unit has a prism shape, includes a light entry surface for passing incident light therethrough, a light reflection surface for reflecting the light passed through the light entry surface and a light exit surface for emitting the light reflected from the light reflection surface, and produces a two-dimensional image by scanning an incident line image on a screen while moving in the direction perpendicular to the scanning direction of the screen.

### CROSS REFERENCE TO RELATED APPLICATION

This application claims the benefit of Korean Patent Application No. 10-2006-0079923, filed on Aug. 23, 2007, entitled “Prism Scanner and Display Apparatus of the Diffractive Optical Modulator using It”, which is hereby incorporated by reference in its entirety into this application.

### BACKGROUND OF THE INVENTION

1. Field of the Invention

The present invention relates generally to a prism scanner and a display device using a diffractive optical modulator and the prism scanner and, more particularly, to a prism scanner, which is implemented using a prism, and a display device using a diffractive optical modulator and the prism scanner, which is implemented using the prism scanner, thereby realizing a small size and low power consumption.

2. Description of the Related Art

With the development of micro technology, Micro-Electro-Mechanical System (MEMS; a super small-sized electrical and mechanical composite) devices and small-sized apparatuses in which MEMS devices are included are attracting attention.

An MEMS device is configured in the form of a microstructure on a substrate, such as a silicon substrate or a glass substrate, and is formed by electrically and mechanically combining an actuation unit for outputting a mechanical actuating force with a semiconductor integrated circuit for controlling the actuation unit. The fundamental feature of such a MEMS device is that an actuator having a mechanical structure constitutes part of the device. The actuator is electrically operated using Coulomb's force between electrodes.

Recently, diffractive optical modulators using such MEMS devices have been developed. FIGS. 1A and 1B show the construction of a Grating Light Value (GLV) 11, which was developed as a diffractive optical modulator.

The GLV 11, as shown in FIG. 1A, is constructed in such a way that a common substrate electrode 13 is formed on an insulated substrate 12, such as a glass substrate, and beams, in the present embodiment, six beams 14 (14₁, 14₂, 14₃, 14₄, 14₅ and 14₆), are arranged parallel to each other across the substrate electrode 13 in a bridge form.

The beams 14, each of which includes a bridge member 15 and an actuation electrode 16 disposed on the bridge member 15 and configured to also function as a reflecting film, are commonly called “ribbons.”

When a small amount of voltage is applied between the substrate electrode 13 and the actuation electrodes 16, which also function as reflecting films, the beams 14 are moved toward the substrate electrode 13 due to the above-described electrostatic phenomenon. In contrast, when the application of the voltage is stopped, the beams 14 are moved away from the substrate electrode 13 and return to the initial positions thereof.

In the GLV device 11, the heights of the actuation electrodes 16 are alternately changed by an operation in which alternate beams 14 are moved toward and away from the substrate electrode 13 (that is, the movement of the beams 14 toward and from the substrate electrode 13), and the intensity of light reflected from the actuation electrodes 16 is modulated by the diffraction of light (a single light spot is radiated onto a total of six beams 14).

Meanwhile, the above-described diffractive optical modulator may be used in various application fields. As an example, the above-described diffractive optical modulator may be used in a display device.

In general, the display device using the prior art diffractive optical modulator includes a light source, an illumination lens, a diffractive optical modulator, a projection system, and a screen.

The light source includes a plurality of light sources, for example, a red light source, a green light source, and a blue light source.

The illumination lens converts light, emitted from the light source, into linear parallel light, and causes the linear parallel light to enter the diffractive optical modulator.

The diffractive optical modulator produces diffracted light having a plurality of diffraction orders by modulating linear parallel light when the linear parallel light is incident thereon. In this case, the diffracted light formed by the diffractive optical modulator is linear diffracted light from the viewpoint of each diffraction order. That is, the diffracted light emitted from the diffractive optical modulator forms a linear scan line in such a way that a plurality of scanned diffracted light spots corresponding to the pixels of an image to be formed on a screen is linearly arranged.

The projection system produces a two-dimensional image by projecting a linear scan line, formed through the arrangement of a plurality of scanned diffracted light spots, onto a screen and scanning the linear scan line across the screen.

As an example, in the case of the universal HDTV standard, one frame of image includes pixels corresponding to a row length K=1080 pixels×a column length L=1920 pixels. In order to output an HDTV-quality image using the above-described diffractive optical modulator, a two-dimensional image is produced by scanning a linear scan line, formed through the linear arrangement of scanned diffracted light spots corresponding to 1080 pixels, in a lateral direction.

The prior art projection and scanning optical unit of such a projection system is shown in FIG. 2. The projection and scanning optical unit produces a two-dimensional image by scanning a scan line, composed of a plurality of scanned diffracted light spots generated by the diffractive optical modulator, across a screen 26.

The projection and scanning optical unit includes a condensing lens 20, a scanner 22, and a projection lens 24, and projects incident diffracted light onto a screen 26.

The condensing lens 20 condenses linear diffracted light, passed through an optical filter or dichroic filter (not shown), so that it is focused on the screen 26. Of course, a concave lens (not shown) may be provided downstream of the condensing lens 20, so that diffracted light, passed through the optical filter or dichroic filter, may be condensed, converted into parallel light and then projected onto the prism scanner 22.

The scanner 22 is an X scanning mirror, and scans an incident line image across the screen 26 from the left to the right and then from the right to the left under the control of a display electronic system, and repeats this operation. A Galvanometer mirror scanner or a polygon mirror scanner may be used as the scanner 22.

Meanwhile, the prior art Galvanometer mirror scanner or polygon mirror scanner has a problem in that a large rotating angle is required to display an image on a screen, so that power consumption is high.

Furthermore, the prior art Galvanometer mirror scanner or polygon mirror scanner has a problem in that a large rotating angle is required to display an image on a screen, so that the volume of the scanner driving motor provided to obtain a high rotating force is large, with the result the realization of a small size is hindered in the case where the display device using a diffractive optical modulator is used in mobile phones.

### SUMMARY OF THE INVENTION

Accordingly, the present invention has been made keeping in mind the above problems occurring in the prior art, and the present invention is intended to provide a prism scanner configured to be able to obtain a large rotation angle using a small action, and a display device equipped with a diffractive optical modulator using the prism scanner.

In order to accomplish the above object, the present invention provides a prism scanner, including a prism scanning unit configured to have a prism shape, to comprise a light entry surface for passing incident light therethrough, a light reflection surface for reflecting the light passed through the light entry surface, and a light exit surface for emitting the light reflected from the light reflection surface, and to produce a two-dimensional image by scanning an incident line image on a screen while moving in the direction perpendicular to the scanning direction of the screen; a drive motor for moving the prism scanning unit in the direction perpendicular to the scanning direction of the screen; and a scanner driving circuit for controlling the drive motor.

Additionally, the present invention provides a display device using a diffractive optical modulator and a prism scanner, including a light source unit for producing and emitting light; an illumination optical unit for converting light, emitted from the light source unit, into linear incident light; a diffractive optical modulator for producing linear diffracted light by modulating linear incident light, emitted from the illumination optical unit, in response to drive signals; and a projection and scanning optical unit for producing an image by scanning the linear diffracted light, emitted from the diffractive optical modulator, across a screen using a prism scanner.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are diagrams showing the construction of a prior GLV;

FIG. 2 is a diagram showing the detailed construction of a prior art projection and scanning optical unit;

FIG. 3A is a perspective view of a prism scanner according to a preferred embodiment of the present invention, and FIG. 3B is a conceptual diagram of the scanning operation of the prism scanner according to the present embodiment of the present invention;

FIG. 4A is a perspective view of a prism scanner according to another embodiment of the present invention, and FIG. 4B is a conceptual diagram of the scanning operation of the prism scanner according to the present embodiment of the present invention;

FIG. 5A is a perspective view of a prism scanner according to still another embodiment of the present invention, and FIG. 5B is a conceptual diagram of the scanning operation of the prism scanner according to the present embodiment of the present invention;

FIG. 6 is a display device equipped with a diffractive optical modulator using a prism scanner according to an embodiment of the present invention; and

FIG. 7 is a diagram showing the detailed construction of the projection and scanning optical unit shown in FIG. 6.

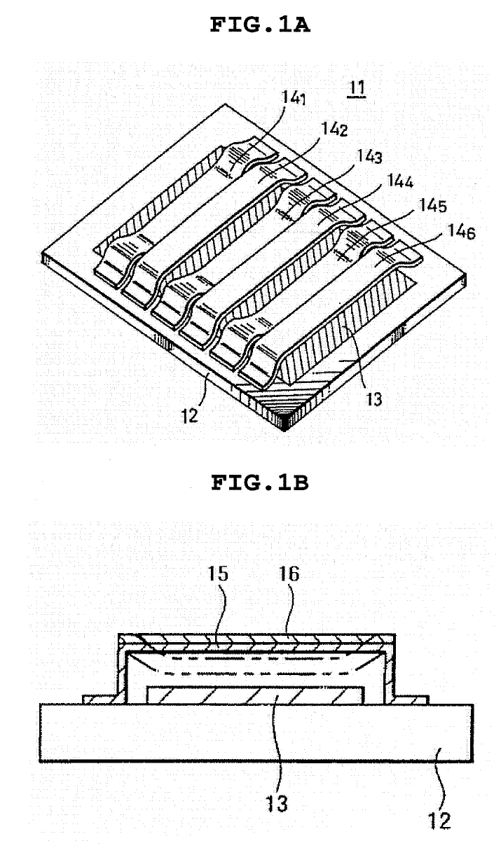

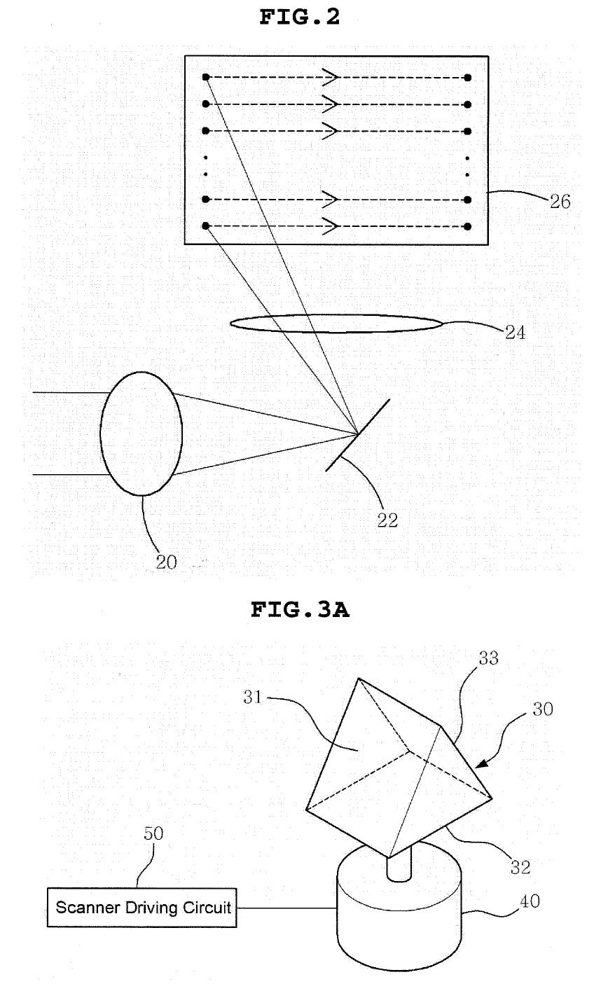

### DESCRIPTION OF THE PREFERRED EMBODIMENTS

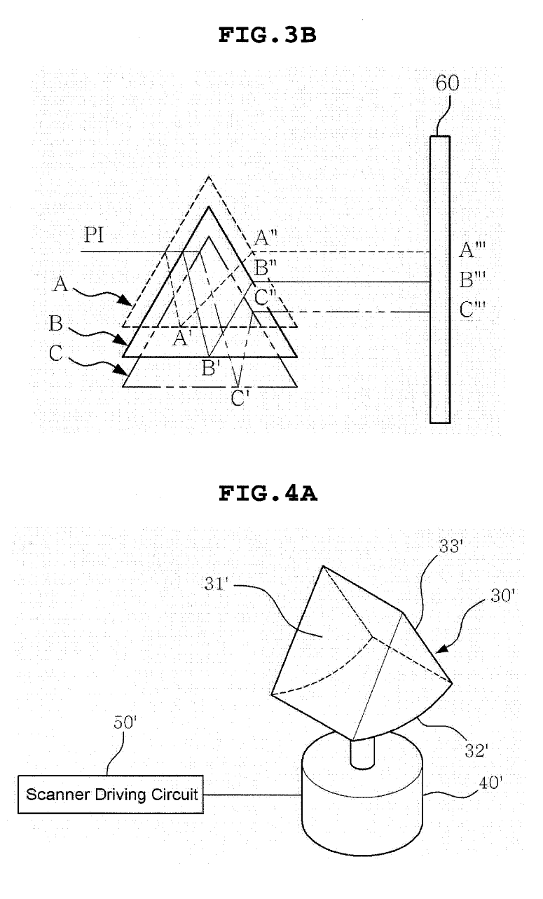

Referring to FIGS. 3A to 7, a prism scanner and a display device equipped with a diffractive optical modulator using the prism scanner according to a preferred embodiment of the present invention are described in detail below.

FIG. 3A is s perspective view of the prism scanner according to the preferred embodiment of the present invention.

Referring to FIG. 3A, the prism scanner according to the preferred embodiment of the present invention includes a prism scanning unit 30, a drive motor 40, and a scanner driving circuit 50.

The prism scanning unit 30 has a prism shape and is made of transparent material. The prism scanning unit 30 includes a flat light entry surface 31 for receiving incident light, a flat light reflection surface 32 for reflecting the incident light passed through the light entry surface 31, and a flat light exit surface 33 for emitting the incident light reflected from the light reflection surface 32.

The angle between the light entry surface 31 and the light reflection surface 30, the angle between the light reflection surface 30 and the light exit surface 33, and the angle between the light exit surface 33 and the light entry surface 31 are preferably acute angles. Of course, according to the application, one or two of the three angles may be obtuse angles.

Meanwhile, the light reflection surface 32 is coated with reflective material so that light passed through the light entry surface 31 is reflected therefrom. According to the application, the light reflection surface 32 may be partially coated with coating material.

The drive motor 40 moves the prism scanning unit 30 vertically, that is, in the direction perpendicular to a scanning direction, under the control of the scanner driving circuit 50.

The scanner driving circuit 50 moves the prism scanning unit 30 vertically by controlling the drive motor 40 in response to external scanner control signals. That is, the scanner driving circuit 50 controls the drive motor 40 so that light emitted from the prism scanning unit 30 can be scanned onto a screen at a uniform speed.

A scanning operation performed by the prism scanner is shown in FIG. 3B, which shows an operation in which incident light is scanned across the screen 60 when the prism scanning unit 30 moves vertically.

Here, FIG. 3B shows an operation in which light is scanned onto the screen 60 when a cycle in which the prism scanning unit 30 moves from a position A through a position B to a position C and then returns to the position A is repeatedly conducted.

In FIG. 3B, when the prism scanning unit 30 is located at the position A and incident light PI enters the light entry surface 31 at the position A, projected light reaches the point A′ of the light reflection surface 32 because the projected angle of the projected light is identical to an incident angle, light reflected from the light reflection surface 32 reaches the point A″ of the light exit surface 33 because the reflected angle of the reflected light is identical to the incident angle of the incident light, and light emitted from the light exit surface 33 reaches the point A′″ of the screen 60 because the emitted angle of the emitted light is identical to an incident angle for the light exit surface 33.

In the same way, when the prism scanning unit 30 is located in a position B and incident light PI enters the light entry surface 31 at the position B, projected light reaches the point B′ of the light reflection surface 32 because the projected angle of the projected light is identical to an incident angle, light reflected from the light reflection surface 32 reaches the point B″ of the light exit surface 33 because the reflected angle of the reflected light is identical to the incident angle of the incident light, and light emitted from the light exit surface 33 reaches the point B′″ of the screen 60 because the emitted angle of the emitted light is identical to an incident angle for the light exit surface 33.

Furthermore, in the same way, when the prism scanning unit 30 is located in a position C and incident light PI enters the light entry surface 31 at the position C, projected light reaches the point C′ of the light reflection surface 32 because the projected angle of the projected light is identical to an incident angle, light reflected from the light reflection surface 32 reaches the point C″ of the light exit surface 33 because the reflected angle of the reflected light is identical to the incident angle of the incident light, and light emitted from the light exit surface 33 reaches the point C′″ of the screen 60 because the emitted angle of the emitted light is identical to an incident angle for the light exit surface 33.

Referring to FIG. 3B, when the prism scanning unit 30 is vertically moved by the drive motor 40, the incident light PI is laterally scanned onto the screen 60 via the prism scanning unit 30.

Unlike a general Galvanometer mirror scanner or polygon mirror scanner, the prism scanning unit 30 can obtain a large rotating angle through a small amount of vertical movement because the rotating angle of incident light based on vertical movement is affected by the light entry surface 31, the light reflection surface 32 and the light exit surface 33, so that power consumption can be reduced, and thus a small-sized drive motor can be employed, thereby realizing a small size.

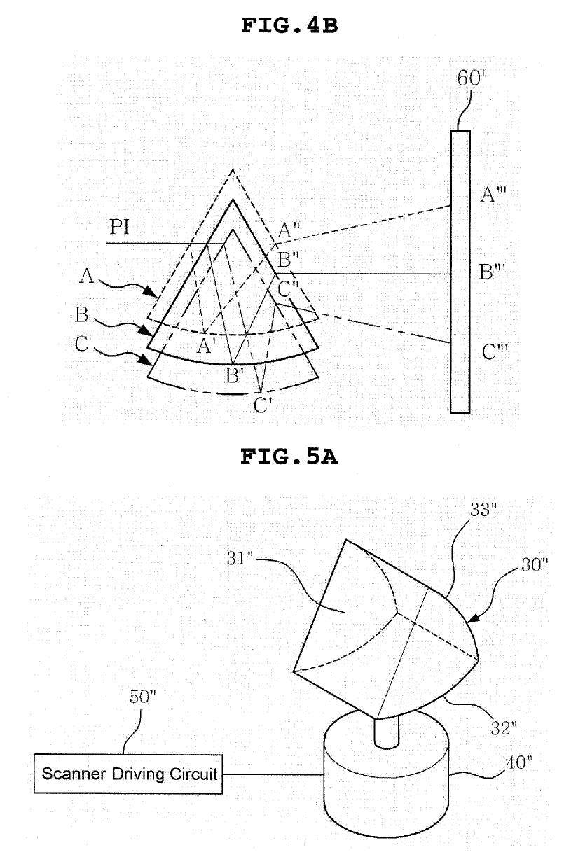

FIG. 4A is a perspective view of a prism scanner according to another embodiment of the present invention.

Referring to FIG. 4A, the prism scanner according to the present embodiment of the present invention includes a prism scanning unit 30′, a drive motor 40′, and a scanner driving circuit 50′.

The prism scanning unit 30′ has a prism shape, and is made of transparent material. The prism scanning unit 30′ includes a flat light entry surface 31′ for receiving incident light, a curved light reflection surface 32′ for reflecting the incident light passed through the light entry surface 31′, and a flat light exit surface 33′ for emitting the incident light reflected from the light reflection surface 32′.

Here, the angle between the light entry surface 31′ and the light reflection surface 30′, the angle between the light reflection surface 30′ and the light exit surface 33′, and the angle between the light exit surface 33′ and the light entry surface 31′ are preferably acute angles. Of course, according to the application, one or two of the three angles may be obtuse angles.

Meanwhile, the light reflection surface 32′ is coated with reflective material so that light passed through the light entry surface 31′ is reflected therefrom. According to the application, the light reflection surface 32′ may be partially coated with coating material.

The drive motor 40′ moves the prism scanning unit 30′ vertically, that is, in the direction perpendicular to a scanning direction, under the control of the scanner driving circuit 50′.

The scanner driving circuit 50′ moves the prism scanning unit 30′ vertically by controlling the drive motor 40′ in response to external scanner control signals. That is, the scanner driving circuit 50′ controls the drive motor 40′ so that light emitted from the prism scanning unit 30′ can be scanned onto a screen at a uniform speed.

A scanning operation performed by the prism scanner is shown in FIG. 4B, which shows an operation in which incident light is scanned across the screen 60′ when the prism scanning unit 30′ moves vertically.

Here, FIG. 4B shows an operation in which light is scanned onto the screen 60′ when a cycle in which the prism scanning unit 30′ moves from a position A through a position B to a position C and then returns to the position A is repeatedly conducted.

In FIG. 4B, when the prism scanning unit 30′ is located at the position A and incident light PI enters the light entry surface 31′ at the position A, projected light reaches the point A′ of the light reflection surface 32′ because the projected angle of the projected light is identical to an incident angle, light reflected from the light reflection surface 32′ reaches the point A″ of the light exit surface 33′ because the reflected angle of the reflected light is identical to the incident angle of the incident light, and light emitted from the light exit surface 33′ reaches the point A′″ of the screen 60′ because the emitted angle of the emitted light is identical to an incident angle for the light exit surface 33′. Here, it can be seen that the point A′″ of the screen 60′ has moved to the left relative to the position of the point A′″ shown in FIG. 3B.

In the same way, when the prism scanning unit 30′ is located in a position B and incident light PI enters the light entry surface 31′ at the position B, projected light reaches the point B′ of the light reflection surface 32′ because the projected angle of the projected light is identical to an incident angle, light reflected from the light reflection surface 32′ reaches the point B″ of the light exit surface 33′ because the reflected angle of the reflected light is identical to the incident angle of the incident light, and light emitted from the light exit surface 33′ reaches the point B′″ of the screen 60′ because the emitted angle of the emitted light is identical to an incident angle for the light exit surface 33′.

Furthermore, in the same way, when the prism scanning unit 30′ is located in a position C and incident light PI enters the light entry surface 31′ at the position C, projected light reaches the point C′ of the light reflection surface 32′ because the projected angle of the projected light is identical to an incident angle, light reflected from the light reflection surface 32′ reaches the point C″ of the light exit surface 33′ because the reflected angle of the reflected light is identical to the incident angle of the incident light, and light emitted from the light exit surface 33′ reaches the point C′″ of the screen 60′ because the emitted angle of the emitted light is identical to an incident angle for the light exit surface 33′. Here, it can be seen that the point C′″ of the screen 60′ has moved to the left relative to the position of the point C′″ shown in FIG. 3B.

As a result, in the comparison of FIG. 3B with FIG. 4B, the prism scanning unit 30′ having the curved light reflection surface 32′ can obtain a larger rotating angle than the prism scanning unit 30 having the flat light reflection surface 32, so that power consumption can be reduced further, with the result that a smaller drive motor can be employed, thereby realizing a smaller size.

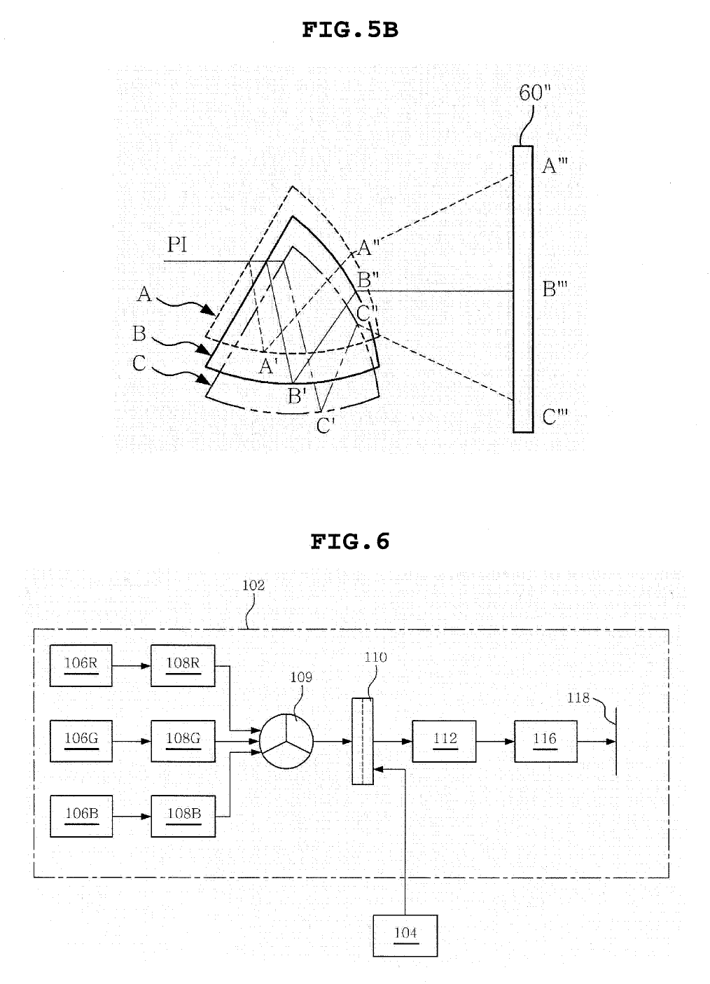

FIG. 5A is a perspective view of a prism scanner according to still another embodiment of the present invention.

Referring to FIG. 5A, the prism scanner according to the present embodiment of the present invention includes a prism scanning unit 30″, a drive motor 40″, and a scanner driving circuit 50″.

The prism scanning unit 30″ has a prism shape, and is made of transparent material. The prism scanning unit 30″ includes a flat light entry surface 31″ for receiving incident light, a curved light reflection surface 32″ for reflecting the incident light passed through the light entry surface 31″, and a curved light exit surface 33″ for emitting the incident light reflected from the light reflection surface 32″.

Here, the angle between the light entry surface 31″ and the light reflection surface 30″, the angle between the light reflection surface 30″ and the light exit surface 33″, and the angle between the light exit surface 33″ and the light entry surface 31″ are preferably acute angles. Of course, according to the application, one or two of the three angles may be obtuse angles.

Meanwhile, the light reflection surface 32″ is coated with reflective material so that light passed through the light entry surface 31″ is reflected therefrom. According to the application, the light reflection surface 32″ may be partially coated with coating material.

The drive motor 40″ moves the prism scanning unit 30″ vertically, that is, in the direction perpendicular to a scanning direction, under the control of the scanner driving circuit 50″.

The scanner driving circuit 50″ moves the prism scanning unit 30″ vertically by controlling the drive motor 40″ in response to external scanner control signals. That is, the scanner driving circuit 50″ controls the drive motor 40″ so that light emitted from the prism scanning unit 30″ can be scanned onto a screen at a uniform speed.

A scanning operation performed by the prism scanner is shown in FIG. 5B, which shows an operation in which incident light is scanned onto the screen 60″ when the prism scanning unit 30″ moves vertically.

Here, FIG. 5B shows an operation in which light is scanned across the screen 60″ when a cycle in which the prism scanning unit 30″ moves from a position A through a position B to a position C and then returns to the position A is repeatedly conducted.

In FIG. 5B, when the prism scanning unit 30″ is located at the position A and incident light PI enters the light entry surface 31″ at the position A, projected light reaches the point A′ of the light reflection surface 32″ because the projected angle of the projected light is identical to an incident angle, light reflected from the light reflection surface 32″ reaches the point A″ of the light exit surface 33″ because the reflected angle of the reflected light is identical to the incident angle of the incident light, and light emitted from the light exit surface 33″ reaches the point A′″ of the screen 60″ because the emitted angle of the emitted light is identical to an incident angle for the light exit surface 33′. Here, it can be seen that the point A′″ of the screen 60″ has moved to the left relative to the position of the point A′″ shown in FIG. 4B.

In the same way, when the prism scanning unit 30″ is located at a position B and incident light PI enters the light entry surface 31″ at the position B, projected light reaches the point B′ of the light reflection surface 32″ because the projected angle of the projected light is identical to an incident angle, light reflected from the light reflection surface 32″ reaches the point B″ of the light exit surface 33″ because the reflected angle of the reflected light is identical to the incident angle of the incident light, and light emitted from the light exit surface 33″ reaches the point B′″ of the screen 60″ because the emitted angle of the emitted light is identical to an incident angle for the light exit surface 33″.

Furthermore, in the same way, when the prism scanning unit 30″ is located at a position C and incident light PI enters the light entry surface 31″ at the position C, projected light reaches the point C′ of the light reflection surface 32″ because the projected angle of the projected light is identical to an incident angle, light reflected from the light reflection surface 32″ reaches the point C″ of the light exit surface 33″ because the reflected angle of the reflected light is identical to the incident angle of the incident light, and light emitted from the light exit surface 33″ reaches the point C′″ of the screen 60″ because the emitted angle of the emitted light is identical to an incident angle for the light exit surface 33″. Here, it can be seen that the point C′″ of the screen 60″ has moved to the left relative to the position of the point C′″ shown in FIG. 4B.

As a result, in the comparison of FIGS. 3B, 4B and 5B with one another, the prism scanning unit 30″ having the curved light reflection surface 32″ and the curved light exit surface 33″ can obtain larger rotating angles than the prism scanning unit 30 having the flat light reflection surface 32 and the flat light exit surface 33, and the prism scanning unit 30′ having the curved light reflection surface 32′ and the flat light exit surface 33′, so that power consumption can be reduced still further, with the result that a still smaller drive motor can be employed, thereby realizing an even smaller size.

FIG. 6 is a display device equipped with a diffractive optical modulator using a prism scanner according to an embodiment of the present invention.

Referring to FIG. 6, the display device equipped with a diffractive optical modulator using a prism scanner according to the present embodiment of the present invention includes a display optical system 102 and a display electronic system 104.

The display optical system 102 includes a red light source 106R, a green light source 106G, a blue light source 106B, an illumination optical unit 108R for a red light source, an illumination optical unit 108G for a green light source, an illumination optical unit 108B for a blue light source, a plate color wheel 109, a diffractive optical modulator 110, a Schlieren optical unit 112, a projection and scanning optical unit 116, and a screen 118.

Here, laser light sources 106R, 106G, and 106B emit laser light. The laser light has, for example, a circular cross section, and the intensity profile of the laser light has a Gaussian distribution.

The illumination optical units 108R, 108G and 108B convert light, emitted from the laser light sources 106R, 106G and 106B, into linear light, so that narrow, long linear light is radiated onto the diffractive optical modulator 110.

The diffractive optical modulator 110 produces diffracted light by modulating linear light emitted from the illumination optical units 108R, 108G and 108B. Here, the plate color wheel 109 is disposed between the illumination optical units 108R, 108G and 108B and the diffractive optical modulator 110, and is divided into three sections, each of the sections being formed to pass only one color light therethrough. Accordingly, when the plate color wheel 109 is rotated and beams of linear light, emitted from the illumination optical units 108R, 108G and 108B, have the same light path, linear light, which enters the diffractive optical modulator 110 via the plate color wheel 109, is time-divided. In this case, if the plate color wheel 109 is divided into, for example, an R region, a G region and a B region, linear light passes through the plate color wheel 109 in the sequence of R light, G light and B light.

When linear light entering the diffractive optical modulator 110 is time-divided and passes through the diffractive optical modulator 110, the diffractive optical modulator 110 produces diffracted light by modulating respective beams of incident light under the control of the optical modulator driving circuit (not shown) of the display electronic system 104, and emits the diffracted light.

The Schlieren optical unit 112 (which may be called a “filter unit”) separates diffracted light, modulated by the diffractive optical modulator 110, according to diffraction order, and passes diffracted light having a desired order among a plurality of beams of diffracted light having respective diffraction orders therethrough.

The Schlieren optical system 112 includes, for example, a Fourier lens (not shown) and a spatial filter or dichroic filter (not shown), and selectively passes 0th-order diffracted light or ±1st-order diffracted light, among incident diffracted light, therethrough.

The projection and scanning optical unit 116 produces a two-dimensional image by scanning a scan line composed of a plurality of diffracted point beams, passed through the Schlieren optical unit 112, onto the screen 118.

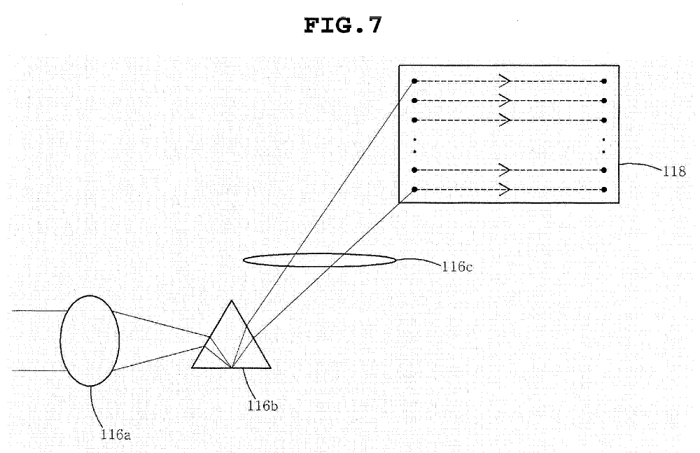

The projection and scanning optical unit 116, as shown in FIG. 7, includes a condensing lens 116a, a prism scanner 116b, and a projection lens 116c, and projects incident diffracted light onto the screen 118.

The condensing lens 116a condenses linear diffracted light, passed through the optical filter or dichroic filter (not shown), so that it is focused on the screen 118. Of course, a concave lens (not shown) may be provided downstream of the condensing lens 116a, so that diffracted light, passed through the optical filter or dichroic filter, may be condensed, converted into parallel light, and then projected onto the prism scanner 116b.

The prism scanner 116b scans a line image across the screen 118 from the left to the right while moving in the direction perpendicular to the scanning direction of the screen 118 under the control of the display electronic system 104, as described above with reference to FIGS. 3A to 5B. This operation is repeated.

In this case, when, for example, the prism scanner 116b scans a red scan line across the screen 118 while first performing scanning from the left to the right, scans a green scan line across the screen 118 while subsequently performing scanning from the left to the right, and scans a blue color across the screen 118 while again performing scanning from the left to the right, one color image composed of red, green and blue is completed.

Meanwhile, although horizontal scanning has been described as an example, the same description can be applied to vertical scanning.

Meanwhile, the above-described prism scanner according to the present invention can obtain a large rotating angle using a small amount of drive so as to display an image on a screen, thereby achieving an advantage of reducing power consumption.

Furthermore, according to the present invention, when the prism scanner is used, a large rotating angle can be obtained so as to display an image on a screen, so that the volume of the scanner driving motor required to obtain necessary rotating force can be reduced, thereby achieving an advantage of realizing a small size when the display device equipped with the diffractive optical modulator is used in a mobile terminal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A prism scanner, comprising:
a prism scanning unit configured to have a prism shape, to comprise a light entry surface for passing incident light therethrough, a light reflection surface for reflecting the light passed through the light entry surface, and a light exit surface for emitting the light reflected from the light reflection surface, and to produce a two-dimensional image by scanning an incident line image on a screen while moving in a direction perpendicular to a scanning direction of the screen;
a drive motor for moving the prism scanning unit in the direction perpendicular to the scanning direction of the screen; and
a scanner driving circuit for controlling the drive motor.

2. The prism scanner as set forth in claim 1, wherein a light entry surface, light reflection surface and light exit surface of the prism scanning unit form acute angles therebetween.

3. The prism scanner as set forth in claim 1, wherein the prism scanning unit has a triangular prism shape.

4. The prism scanner as set forth in claim 1, wherein the prism scanning unit has a curved light reflection surface.

5. The prism scanner as set forth in claim 1, wherein the prism scanning unit has a curved light exit surface.

6. The prism scanner as set forth in claim 1, wherein the prism scanning unit has a curved light reflection surface and a curved light exit surface.

7. The prism scanner as set forth in claim 1, wherein the scanner driving circuit controls the drive motor so that a line image, scanned onto the screen by the prism scanning unit, has uniform speed at all points.

8. A display device using a diffractive optical modulator and a prism scanner, comprising:
a light source unit for producing and emitting light;
an illumination optical unit for converting light, emitted from the light source unit, into linear incident light;
a diffractive optical modulator for producing linear diffracted light by modulating linear incident light, emitted from the illumination optical unit, in response to drive signals; and
a projection and scanning optical unit for producing an image by scanning the linear diffracted light, emitted from the diffractive optical modulator, across a screen using a prism scanner.

9. The display device as set forth in claim 8, wherein the prism scanner of the projection and scanning optical unit comprises:
a prism scanning unit configured to have a prism shape, to comprise a light entry surface for passing incident light therethrough, a light reflection surface for reflecting the light passed through the light entry surface, and a light exit surface for emitting the light reflected from the light reflection surface, and to produce a two-dimensional image by scanning an incident line image on a screen while moving in a direction perpendicular to a scanning direction of the screen;
a drive motor for moving the prism scanning unit in the direction perpendicular to the scanning direction of the screen; and
a scanner driving circuit for controlling the drive motor.

10. The display device as set forth in claim 9, wherein the prism scanning unit has a triangular prism shape.

11. The display device as set forth in claim 9, wherein the prism scanning unit has a curved light reflection surface.

12. The display device as set forth in claim 9, wherein the prism scanning unit has a curved light exit surface.

13. The display device as set forth in claim 9, wherein the prism scanning unit has a curved light reflection surface and a curved light exit surface.

14. The display device as set forth in claim 9, wherein the scanner driving circuit controls the drive motor so that a line image, scanned onto the screen by the prism scanning unit, has uniform speed at all points.

15. The display device as set forth in claim 8, wherein the diffracted light emitted from the diffractive optical modulator is diffracted light having a plurality of diffraction orders,
further comprising a filter unit disposed downstream of the diffractive optical modulator and configured to pass diffracted light having at least one desired diffraction order, selected from the diffracted light having a plurality of diffraction orders, therethrough.

16. The display device as set forth in claim 15, wherein the filter unit comprises:
a Fourier lens for separating the diffracted light having a plurality of diffraction orders, emitted from the diffractive optical modulator, according to diffraction order; and
a filter for selecting the diffracted light having at least one desired diffraction order from the diffracted light having a plurality of diffraction orders passed through the Fourier lens, and passing the selected diffracted light therethrough.
